(19) United States
(12) Patent Application Publication
(10) Pub. No.: US 2025/0225833 A1
(43) Pub. Date: Jul. 10, 2025

(54) HOT FOOD VENDING MACHINE

(71) Applicant: Rodrigo BAPTISTA BAROCIO, Cuauhtémoc (MX)

(72) Inventor: Rodrigo BAPTISTA BAROCIO, Cuauhtémoc (MX)

(21) Appl. No.: 17/787,743

(22) PCT Filed: Nov. 23, 2020
(86) PCT No.: PCT/MX2020/050044

§ 371 Date: Jun. 21, 2022

(51) Int. Cl. G07F 11/58; G07F 17/00

(52) U.S. Cl. CPC G07F 11/58; G07F 17/0078

(57) ABSTRACT

An improved apparatus for baking, cooking, heating and retailing of hot food is provided. The apparatus is manually fed with prepared food items in a line of trays and manually programmed to complete the cycle of required baking, cooking or heating of the food item, depending on the type of food. The punnets transport the product to an oven, in which the required baking, cooking or heating process will be completed to later pass to a warm area to pass to be picked by the user. Food items that have not been sold after a certain time will be discarded automatically.

### FIELD OF INVENTION

The present invention is directed to the fast food field. Particularly, the present invention refers to a vending machine for hot food that allows self-service of baked, cooked or instantly heated food upon customer's request.

### BACKGROUND OF THE INVENTION

For a long time, the way to obtain a hot food vending machine which allows self-service of baked, cooked to instantly heated food has been sought. In accordance with this, are the documents CN103413380A, FR2614714A1, FR2821524A1, USD674020, which divulge vending machines of hot food items that, even though they are instantly heated, they are already precooked and stored for long periods of time, or are reheated several times when they are not sold, which propitiate that said food items lose their flavor and consistency.

It results from the above that there is a need for a hot food vending machine that allows self-service of baked, cooked or instantly heated food upon customer's request that are fresh and have a pleasant consistency.

### SUMMARY OF THE INVENTION

It is an object of the present invention to provide a hot food vending machine that allows self-service of baked, cooked or instantly heated food.

Another object of the present invention is to provide a hot food vending machine in which the food items that have not been sold after a predetermined time are automatically discarded.

These and other objectives will be achieved through a hot food vending machine mainly made up of: a substantially rectangular housing which has a posterior feeding port and a frontal dispensing port; said housing internally comprises a first plurality of trays or punnets designed to contain and transport individual food items for human consumption, in which said first plurality of trays are arranged and separated equidistant from each other in an endless conveyor chain, in order to form a food reception section; an electric resistance heating tunnel type oven, which comprises inside said tunnel an endless conveyor belt that comprises three sections: a reception section, a heating section and a cooling section, where the reception section receives individual food items from the first plurality of trays in order to be baked, cooked or heated for a programmed time in the heating section to later pass to the cooling section, where once they leave the oven tunnel said food items are cooled through a series of fans in order to lower their temperature and make them fit to be consumed by the user without burning; a second plurality of trays or punnets, which just like the first plurality of trays and punnets, are arranged and separated equidistant from each other in an endless conveyor chain, to form a food vending section, where said second plurality of trays receives the cooled individual food items from the cooling section of said oven conveyor chain and transports them to the housing frontal exit port in order to be consumed or, if they are not sold, to be automatically discarded.

The additional features and advantages of the invention should be more easily comprehended through the detailed description of its preferred realization, provided through non-limiting examples with reference to the attached drawings.

### BRIEF DESCRIPTION OF THE DRAWINGS

FIG. 1 is a schematic view of a hot food vending machine in accordance with the present invention which schematically shows its different components.

FIG. 2 is a front view of a hot food vending machine in accordance with the present invention.

FIG. 3 is a back view of a hot food vending machine in accordance with the present invention.

FIG. 4 is a perspective view of the resistance heating tunnel type oven of the hot food vending machine of the present invention.

### DETAILED DESCRIPTION AND BEST MODE OF IMPLEMENTATION

The following detailed description of the embodiments of the invention refers to the attached figures. Although the description includes exemplary embodiments, other embodiments or changes to the described ones are also possible without departing from the intention and scope of the invention. Those skilled in the art should appreciate that the configurations disclosed in the following embodiments represent configurations proposed by the inventors for the operation of the invention in practice. However, those skilled in the art should appreciate that many changes can be made in the specific embodiments that are disclosed herein obtaining a result that does not depart from the spirit and scope of the invention.

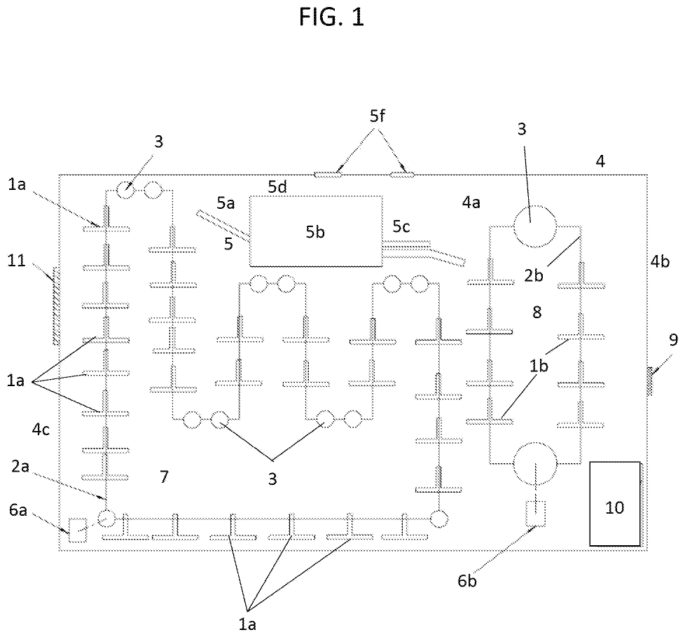

FIG. 1, shows a hot food vending machine which, among its features, presents a first plurality of trays 1a which are suspended and separated from each other in order to store individual food items for human consumption, this first plurality of trays 1a are introduced into the machine through a loading port 11 and attached at their ends to the bolts of a first conveyor chain 2a which allows its vertical rotation due to the movement of the first conveyor chain 2a is a metal chain that acts as an endless conveyor chain in a food storage area 7. This first conveyor chain 2a, powered by a first motor 6a, is tensioned through a uniformly distributed pulley system in which the rotational elements 3 are anchored to a substantially rectangular metal housing 4 that provides support and structure to the machine. This way, the food items are transported in a zig-zag trajectory that runs from top to bottom with the purpose of gaining storage space in order to finally be deposited over a reception section 5a of a moving metal conveyor band 5 that is part of an electric resistance heating tunnel type oven 5d. In order for the food items to be baked, cooked or heated for a predefined period of time to finally be available for a consumer, the conveyor band 5 moves through a chain drive to a heating section 5b where the movement is transmitted from a driving element such as an electric motor, to a plurality of rotational elements, in this particular case each plurality of rotational elements can be a mechanical sprocket.

This machine also incorporates a pair of fans 5f to cool the food items once they have been inside the oven for a time programmed to later transit for a cooling section 5c in which the food items are transported for a programmed time inside of a second plurality of trays 2b before being deposited into an output box 9 in order to be taken by a consumer that will be located in the front part of the self-service machine which is, at the same time, manually supplied by a food dispatcher from the back of the machine, allowing self-service of baked, cooked or instantly heated food upon consumer's request.

The first conveyor chain 2a is disposed vertically, in such a way that it forms simple loops along the support structure and runs around a plurality of rotational elements 3, in said first conveyor chain 2a is suspended the plurality of trays 1a in such a way that at all times each of the plurality of trays 1a stays in a vertical position.

The conveyor band 5 moves at a determined speed in order to receive a food item from the first conveyor chain 2a. Said conveyor band 5 transports the product passing through the oven 5d which has a certain temperature until the food item is unloaded through a second conveyor chain 2b powered by a second motor 6b to a food vending area 8, where it is transported to the housing 4's frontal output box 9 in order to be consumed or, if they are not sold, to be automatically discarded to a trash bin 10. The set of fans 5f is coupled to an extraction duct that circulates the air flow from the inside of the oven 5d to the outside. The housing 4 is made of steel and includes side walls 4a, a front wall 4b and a back wall 4c, where the back wall 4c includes the loading port 11 by which a piece of the product is supplied in each of the first plurality of trays 1a. Each of the side walls 4a, the back wall 4c and the front wall 4b include a thermal coating to avoid dissipating heat, and where each of the side walls 4a, the back wall 4c and the front wall 4b are areas disposed to display advertisement.

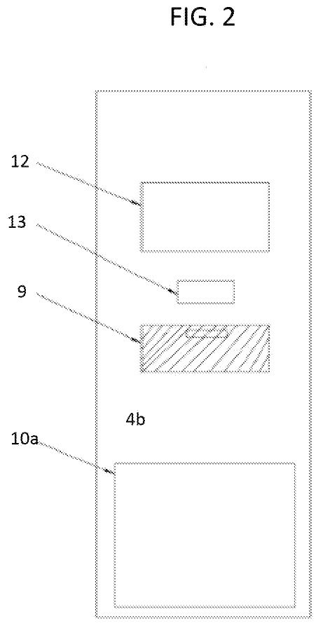

FIG. 2 shows that the front wall 4b includes a user interface having at least one screen 12 and a vending port 13 which is connected to the second motor 6b of the second conveyor chain 2b and the tray is removed from the output box 9 through an opening at the bottom in the front wall 4b of the housing 4. The figure also shows a trash bin door 10a. The first conveyor chain 2a includes tensioning elements that allow adjusting its tension. The apparatus for baking, cooking, heating and retailing, is characterized in that the food product is of any kind and the speed of the conveyor band 5 and the oven 5d temperature are adjusted manually based on the type of food product.

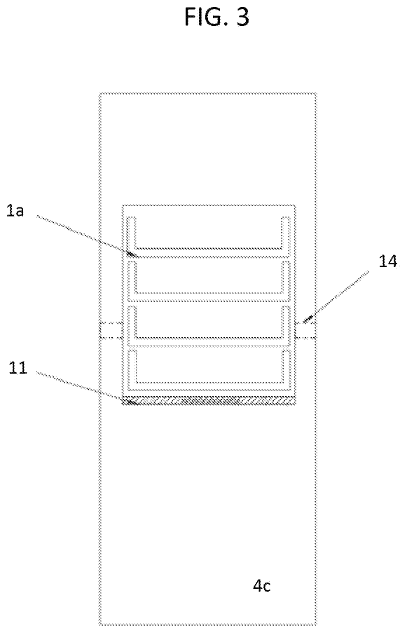

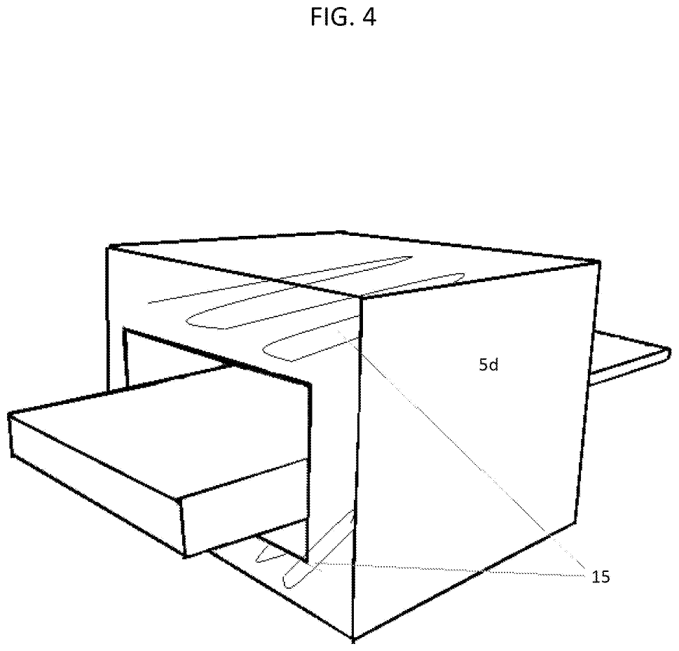

FIG. 3 shows the back wall 4c of the housing 4, loading buttons 14, and a plurality of trays 1a in the loading port 11. FIG. 4 shows the oven 5d having resistors 15.

In accordance with the above, it will be evident to a technician in the field that the modalities of the hot food vending machine of the present invention and its components described above are presented for illustrative purposes only, since a technician in the field can make numerous variations to it, as long as hey are designed in accordance with the principles of the present invention.

As a consequence of the above, the present invention includes all the modalities that a technician in the field can present from the concepts contained in this description, in accordance with the following claims.

1. A hot food vending machine comprising:
a) a substantially rectangular housing, said housing comprising a loading port and an output box;
b) a first plurality of trays designed to contain and transport individual food items for human consumption, wherein said first plurality of trays are arranged and separated equidistant from each other in a first conveyor chain, forming a food storage area;
c) an electric resistance heating tunnel type oven, said oven comprising a conveyor belt, said conveyor belt comprising a reception section, a heating section and a cooling section, wherein the reception section receives individual food items from the first plurality of trays in order to be baked, cooked or heated for a programmed time in the heating section to later pass to the cooling section, where said food items are cooled through a series of fans; and
d) a second plurality of trays arranged and separated equidistant from each other in a second conveyor chain, to form a food vending area, where said second plurality of trays receives the cooled individual food items from the cooling section of said oven conveyor band and transports said second plurality of trays to said output box.

2. The hot food vending machine, in accordance to claim 1, wherein the housing is made out of steel and includes side walls, a front wall and a back wall.

3. The hot food vending machine, in accordance to claim 2, wherein each one of the side walls, the back wall and the front wall include a thermic coating to avoid dissipating heat, and where each of the side walls, the back wall and the front wall are areas disposed to display advertisement.
